(19) United States
(12) Patent Application Publication
(10) Pub. No.: US 2007/0182539 A1
(43) Pub. Date: Aug. 9, 2007

(54) Emergency area confinement and safety system and the method using the same

(76) Inventor: Ethan Ho, Taipei Hsien (TW)

Correspondence Address: ETHAN HO, 235 Chung-Ho, Box 8-24, Taipei, TW

(21) Appl. No.: 11/347,847

(22) Filed: Feb. 6, 2006

(51) Int. Cl. G08B 29/00

(52) U.S. Cl. 340/506

(57) ABSTRACT

An emergency area confinement and safety system includes a central control unit for integrating all the other units in the system. A detector unit for detecting accidents occurred in a building unit. An accident determination unit receives signals from the detectors and determining whether an accident has occurred. The accident determination unit has an accident determination logic unit for determining an accident being occurred; a contour setting unit for defining a contour as an unsafe area. The contour setting unit receives the signals from the accident determination unit to know which section has accident and then determines an unsafe area according to the detecting cells; and a guiding unit for guiding people to run away from the accident area to a safety area; and a display unit in the central control unit for displaying the states.

### FIELD OF THE INVENTION

The present invention relates to emergency systems, and in particular to an emergency area confinement and safety system for isolating accident areas from safety areas and about the emergency evacuation of people out of a building or the like when abnormal conditions or accident occurs. A method using the system is also disclosed.

### BACKGROUND OF THE INVENTION

Emergency alter systems are widely used in the prior art. There are many patents which disclosed the emergency alter systems. One example is U.S. Pat. No. 4,347,499. The patent relates to an emergency guidance system which provides a plurality of discernable means which are electronically interconnected to provide a sequentially pulsed system that is responsive to sensing means that determine the availability of an exit for use in the event of a catastrophe. Control means are provided that evaluate the input from the sensing means and dependent upon availability of exits cause the discernible means to cycle sequentially through predetermined patterns dictated by the available exits.

In another example, U.S. Pat. No. 6,472,994, a line of illuminated electrically powered exit indicators, each having a power backup is mounted on one surface of a non-conductive tape-like support which is flexible enough to be formed into a roll and bend around corners. The exit indicators and the electric circuits are mounted on one surface of the support. A strong adhesive is applied to the opposite surface of the support so that the exit indicators can be easily attached by the adhesive to surfaces of corridors. The tape-like support is provided with a device which permits the tape-like support to be easily unrolled without stressing the electric circuits on the surface of the tape-like support roll.

In a further example, U.S. Pat. No. 5,140,301, a guidance apparatus in case of emergency evacuation comprising a laser which is disposed within a building or the like in such way that a laser beam emitted from the laser is directed in the direction in which evacuees must escape or is directed from the side of an emergency exit toward the interior of the building or the like; abnormal condition detection means for detecting the occurrence of an abnormal condition in the building or the like and generating a detection signal representative of the occurrence of an abnormal condition; and a control unit which is connected to the laser and the abnormal condition detection means and which, in response to the detection signal, energizes the laser. When an abnormal condition such as a fire occurs within the building or the like, the detection means detects the occurrence of an abnormal condition and generates a detection signal, in response to which the laser is energized to emit a laser beam directing the direction in which evacuees must escape.

However, the above-described guidance method or device in the case of emergency evacuation by shouting in loud voices or turning on lighting equipment is almost ineffective when people are seized with panic and if the guidance of people to a safe place by the guides is not carried out satisfactorily and properly, the guidance method and device using guides is also ineffective.

### SUMMARY OF THE INVENTION

Accordingly, the primary object of the present invention is to provide an emergency area confinement and safety system for isolating accident areas from safety areas and about the emergency evacuation of people out of a building or the like when abnormal conditions or accident occur. A method using the system is also disclosed.

To achieve above objects, the present invention provides an emergency area confinement and safety system. The system comprises a central control unit for integrating all the other units in the system; a detector unit for detecting accidents occurred in a building unit; the detector unit having a plurality of detectors; the detectors being installed to different locations for detecting the conditions of the respective area; each detector is set with a detecting cell; an accident determination unit installed in the central control unit; the accident determination unit receiving signals from the detectors and determining whether an accident is occurred; the accident determination unit having an accident determination logic unit for determining an accident being occurred; the accident determination logic unit storing some logics for determining a possible accident; a contour setting unit for defining a contour as an unsafe area; the contour setting unit receiving the signals from the accident determination unit to know which section has accident and then determines an unsafe area according to the detecting cells; an isolation unit for isolating the unsafe area from the safety contour; an accident elimination unit for eliminating the accident in the unsafe area; an informing unit for informing the accident to people in the building unit; a receiving unit for receiving wireless signals from the informing unit to know messages about the occurring of an accident; the receiving unit including at least one wireless receiver; a guiding unit for guiding people to run away from the accident area to a safety area; and a display unit in the central control unit for displaying the states.

Furthermore, the present invention provides a method for defining emergency area and solving an accident according to the present invention. The method comprises the steps of detecting accidents occurred in a building unit by using an detector unit having a plurality of detectors; the detectors being installed to different locations for detecting the conditions of the respective area; each detector is set with a detecting cell; receiving signals from the detectors and determining whether an accident is occurred by using an accident determination unit; the accident determining unit having an accident determination logic unit for determining an accident being occurred; the accident determination logic unit storing some logics for determining a possible accident; defining a contour as an unsafe area by using a contour setting unit; wherein the contour setting unit receiving the signals from the accident determination unit to know which section has accident and then determines an unsafe area according to the detecting cells; isolating the unsafe area from the safety contour by using an isolation unit; eliminating the accident in the unsafe area by using an accident elimination unit; informing the accident to people in the building unit by an informing unit; receiving wireless signals from the informing unit to know messages about the occurring of an accident by using a receiving unit; guiding people to run away from the accident area to a safety area; and displaying the states.

The various objects and advantages of the present invention will be more readily understood from the following detailed description when it is read in conjunction with the appended drawings.

### BRIEF DESCRIPTION OF THE DRAWINGS

FIG. 1 shows a block diagram about the system of the present invention.

FIG. 2 shows one example about the arrangement of the present invention.

FIG. 3 shows the block diagram about the contour determination of the present invention.

FIG. 4 shows the block diagram about the informing unit of the present invention.

FIG. 5 shows the block diagram about the guiding unit of the present invention.

FIG. 6 shows a structure example of the transmitter used in the present invention.

FIG. 7 shows a structure example of the receiver used in the present invention.

FIG. 8 shows the flow diagram about the process of the present invention.

### DETAILED DESCRIPTION OF THE INVENTION

In order that those skilled in the art can further understand the present invention, a detailed description follows. However, these descriptions and the appended drawings are only used to cause those skilled in the art to understand the objects, features, and characteristics of the present invention, but not to be used to confine the scope and spirit of the present invention defined in the appended claims.

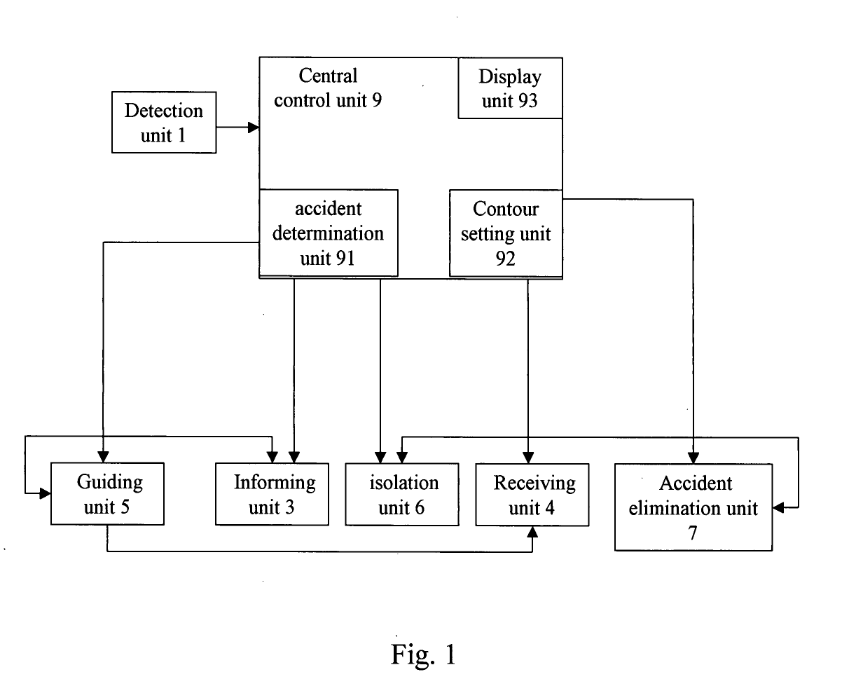

Please referring to FIGS. 1 to 5, the emergency area confinement and safety system of the present invention is illustrated. In this embodiment, a structure about the emergency area confinement and safety system of the present invention will be introduced.

A central control unit 9 serves for integrating all the other units in the system.

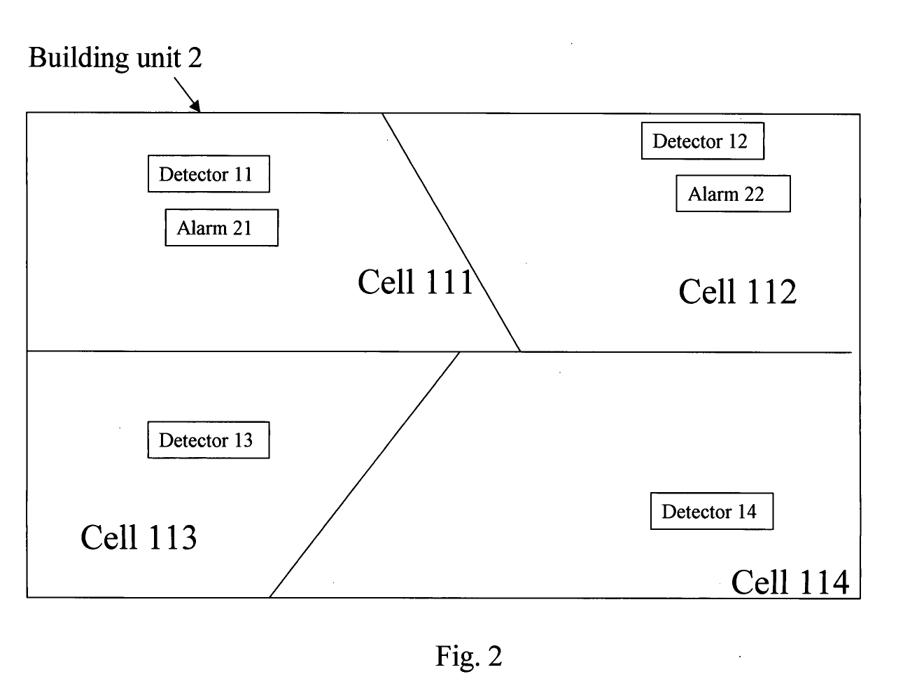

A detector unit 1 serves to detect the possible accidents which can be occurred in a building unit 2. The detector unit 1 has a plurality of detectors 11, 12, 13, and 14 in FIG. 2. The detectors 11 to 14 are installed to different locations for detecting the conditions of the respective area. Each detector is set with a detecting cell 111, 112, 113, and 114 which covers an area in that the detector can detect desired data. The numbers of the detectors and cells are not confined by four, other numbers are permissible, all of these are within the scope of the present invention.

In the present invention, the building unit 2 may be for example, a hotel, a hospital, a plant (for example, a power plant), a bus station, a train station, a school, a theatre, an office building or a cruise ship, etc. However in this embodiment, a hotel is used as an example to describe the present invention. The accident is for example fire accident, earthquake, etc. In this embodiment, a fire accident is used as an example to describe the present invention. Thereby, the detector is a fire sensor.

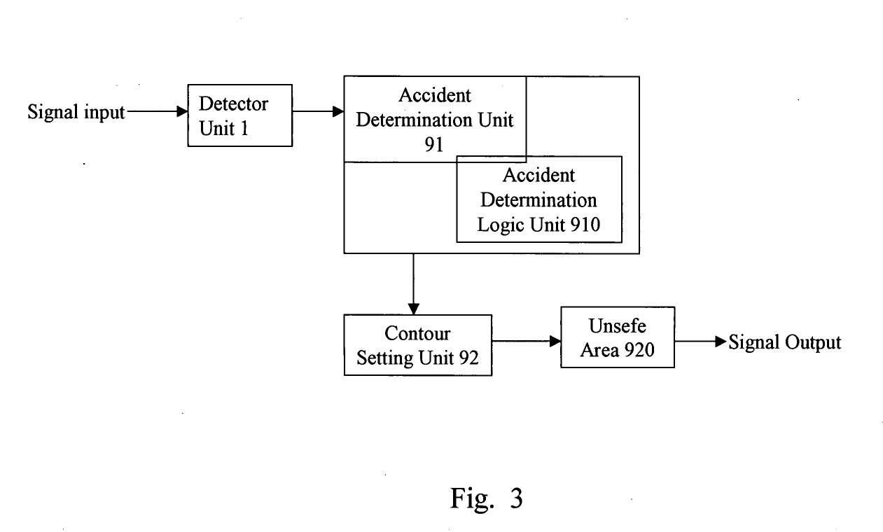

An accident determination unit 91 is installed in the central control unit 9, see FIG. 1. The accident determination unit 91 receives signals from the detectors and determines whether an accident has occurred. The accident determination unit 91 has an accident determination logic unit 910 (referring to FIG. 3) for determining an accident being occurred. The accident determination logic unit 910 stores some logics for determining a possible accident.

A contour setting unit 92 (referring to FIG. 1) serves for defining a contour as an unsafe area. For example, when a fire accident occurs, there are three detectors detect the condition, then the unsafe contour is the combination of the detecting cells containing the detectors. The contour setting unit 92 receives the signals from the accident determination unit 91 to know which section has accident and then determines an unsafe area 920 according to the detecting cells.

An isolation unit 6 (referring to FIG. 1) serve to isolate the unsafe area 920 from the safety contour. For example, the doors or paths to the unsafe area 920 are isolated.

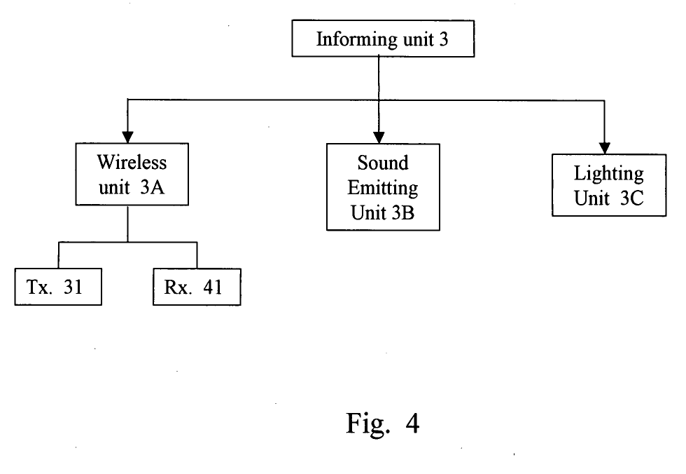

An accident elimination unit 7 (referring to FIG. 1) serves for eliminating the accident by for example spraying water in the unsafe area 920 as in a fire accident case. An informing unit 3 (referring to FIGS. 1 and 4) serves to inform the accident to people in the building unit 2. In the present invention, the informing unit 3 includes a wireless transmitting unit 3A which includes at least one transmitter 31 for transmitting wireless signals. When the detector 11 detects that an accident occurs, the transmitter 31 will emit signals to inform the accident to other people. In a preferable example, the transmitter 31 is installed aside or near a door so that the people can go toward the safety place for running away. However this is only one scope of the present invention, it does not confine the scope of the present invention. For example, in a plant, the transmitter 31 may be placed in one end of a running path.

A receiving unit 4 serves for receiving wireless signals from the informing unit 3 (at least one transmitter 31) so as to know the message about the occurring of an accident. The receiving unit 4 includes at least one wireless receiver 41.

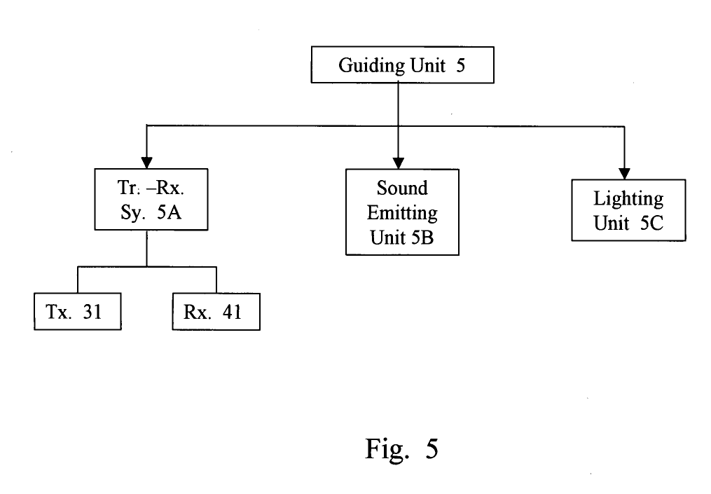

A guiding unit 5, referring to FIGS. 1 and 5, serves for guiding people to run away from the accident area to a safety area. The guiding unit 5 includes at least one sub-unit. One sub-unit 5A is a wireless transmitter-receiver unit SA which includes at least one transmitter 3 1 and at least one receiver 41.

In the present invention, the transmitter 3 1 is associated to respective detectors, for example detector 11. If the detector 11 is actuated to sense and find that an accident occurs, then the associated transmitter 31 will actuate so as to transmit signal. It should be noted that the transmitter 3 1 is out of an area covered by the associated detector 11 so that an area is detected to occur an accident, the associated transmitter 31 not within the area will emit signals to inform people to run out and then the transmitter 31 is also used to guide people to run out of the area. The detector 11 is connected to the transmitter 31 by wired or wireless connection. Wireless connection is preferable since it can prevent the connection from being damaged due to the accident.

In the present invention, the receiver 41 is installed in a key, a flashlight, an oxygen mask, an indicator box, a TV controller, a mobile phone, or a rescuing cloth used in a boat or a plane.

Furthermore, in the present invention, the central control unit 9 further includes a display unit 93 (referring to FIG. 1) for displaying the states, such as the detections of the detector unit 1, the unsafe contour 92, etc.

In the present invention some sub-units can work with the wireless transmitter-receiver unit SA. With reference to FIG. 5, one of the sub-units is a sound emitting unit SB serves to guide the people to escape from an accident area by sounds. The sound emitting unit 5B works with the wireless transmitter-receiver unit 5A. As the transmitter 31 emits informing signals to the receiver 41. The sound emitting unit 5B still actuate so as to emit sound to guide people to run out from the accident area.

A further sub-unit is a lighting unit 5C which emits light to guide people to run out of the accident area. The lighting unit 5C has a plurality of lighting devices. Each lighting device has at least one associated transmitter 31. The lighting unit can alert people to run along a safety path. In a path to a safety door or an emergency door, there may be a plurality of lighting devices are installed. Strong light is used to indicate a correct path and weak light indicates a wrong path. Thereby people can easily run away from the accident area.

Referring to FIG. 5, in the present invention, all the sub-units 5A, 5B and 5C of the guiding unit 5 can be integrated as illustrated. Namely, the transmitter 31 in the sub-unit 5A has associated elements. If the transmitter 31 actuates, only related devices connected thereto will actuate. Thereby if one transmitter 31 is near the accident area, the related devices will not actuate and thus people will not be guided along the path guided by these devices.

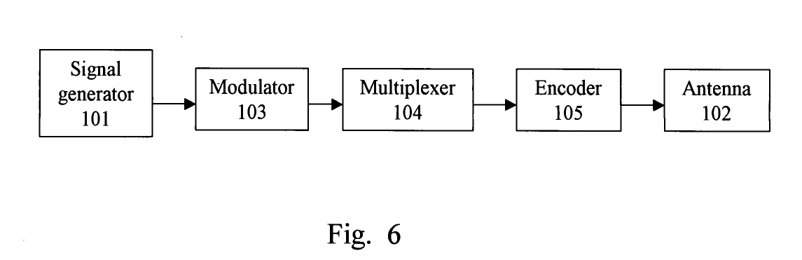

A circuit structure about the transmitter of the present invention is illustrated in FIG. 6, the transmitter 31 includes a signal generator 101, an antenna 102, a modulator 103, a multiplexer 104 and an encoder 105.

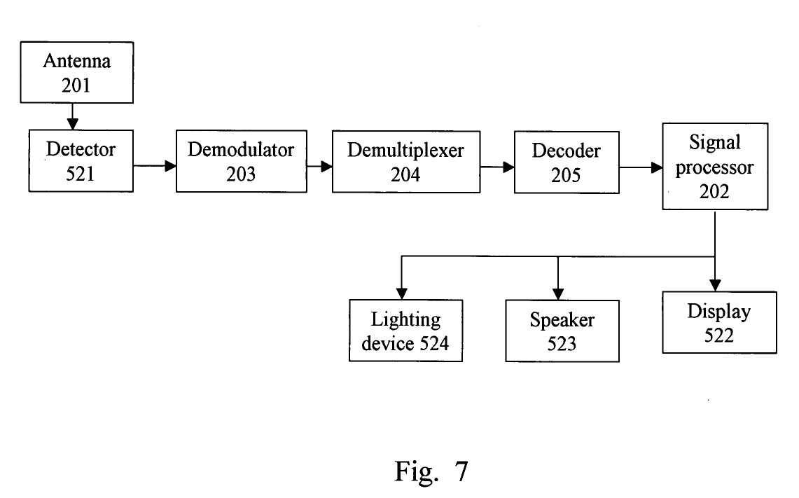

Referring to FIG. 7, the receiver 41 includes a detector 521 for detecting the strengths of the signals transmitted from the transmitter 31 to the receiver 41, a display 522 for displaying the strengths of the signals, a speaker 523 which emits sound according to the strengths of the signals, for example a great sound for strong strength and a lighting device 524 which can emit light to alert people to run away along a predetermined path. Thereby people in the accident occurring place can run away according to the guiding of the volume of the sound from the speaker 523. Since in the present invention, the actuated transmitter 31 is generally installed near an emergency door. The greater the strength of the signal (or the volume of the sound). Thereby people can go to the emergency door.

In FIG. 7, wherein it is illustrated that the receiver 41 has an antenna 201, a signal processor 202, a demodulator 203, a demultiplexer 204, and a decoder 205 other than the above mentioned display 522 and the speaker 523 or the light device 524.

In the present invention, the guiding of the running away path can be achieved by the design of antenna beam. The directivity of the antenna beam can be used to match a run-away path.

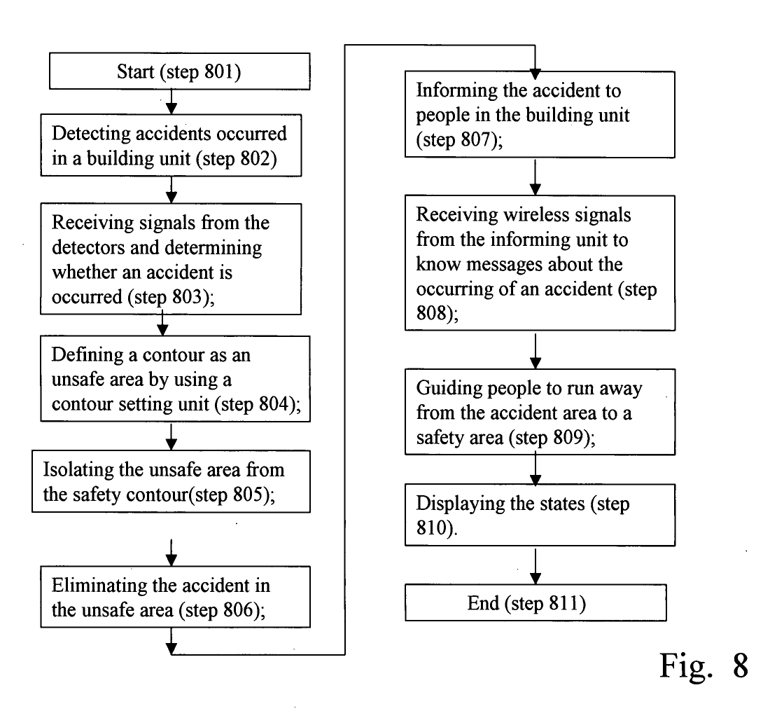

Furthermore, referring to FIG. 8, a method for defining emergency area and solving an accident according to the present invention is illustrated. The method comprises the steps of starting the process from step 801; detecting accidents occurred in a building unit (step 802) by using an detector unit having a plurality of detectors; the detectors being installed to different locations for detecting the conditions of the respective area; each detector is set with a detecting cell; receiving signals from the detectors and determining whether an accident has occurred by using an accident determination unit (step 803); the accident determining unit having an accident determination logic unit for determining an accident being occurred; the accident determination logic unit storing some logics for determining a possible accident; defining a contour as an unsafe area by using a contour setting unit (step 804); wherein the contour setting unit receiving the signals from the accident determination unit to know which section has accident and then determines an unsafe area according to the detecting cells; isolating the unsafe area from the safety contour by using an isolation unit (step 805); eliminating the accident in the unsafe area by using an accident elimination unit (step 806); informing the accident to people in the building unit by an informing unit (step 807); receiving wireless signals from the informing unit to know messages about the occurring of an accident by using a receiving unit (step 808); guiding people to run away from the accident area to a safety area (step 809); and displaying the states (step 810). The process is ended at step 811.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An emergency area confinement and safety system comprising:
a central control unit for integrating all the other units in the system;
a detector unit for detecting accidents occurred in a building unit; the detector unit having a plurality of detectors; the detectors being installed to different locations for detecting the conditions of the respective area; each detector being set with a detecting cell;
an accident determination unit installed in the central control unit; the accident determination unit receiving signals from the detectors and determining whether an accident has occurred; the accident determination unit having an accident determination logic unit for determining an accident being occurred; the accident determination logic unit storing some logics for determining a possible accident;
a contour setting unit for defining a contour as an unsafe area; the contour setting unit receiving the signals from the accident determination unit to know which section has accident and then determines an unsafe area according to the detecting cells;
an isolation unit for isolating the unsafe area from the safety contour;
an accident elimination unit for eliminating the accident in the unsafe area;
an informing unit for informing the accident to people in the building unit
a receiving unit for receiving wireless signals from the informing unit to know messages about the occurring of an accident; and the receiving unit including at least one wireless receiver;
a guiding unit for guiding people to run away from the accident area to a safety area; and
a display unit in the central control unit for displaying the states.

2. The emergency area confinement and safety system as claimed in claim 1, wherein the building unit is one of a hotel, a hospital, a plant, a power plant a bus station, a train station, a school, a theatre, an office building, or a cruise ship.

3. The emergency area confinement and safety system as claimed in claim 1, wherein the informing unit includes a wireless transmitting unit which includes at least one transmitter for transmitting wireless signals.

4. The emergency area confinement and safety system as claimed in claim 1, wherein the guiding unit includes a wireless transmitter-receiver unit which includes at least one transmitter and at least one receiver.

5. The emergency area confinement and safety system as claimed in claim 4, wherein the transmitter is associated to respective detectors; if the detector is actuated so as to sense that an accident occurs, and then the associated transmitter will actuate so as to transmit signal to receivers for informing people to run away.

6. The emergency area confinement and safety system as claimed in claim 5, wherein the receiver includes a detector for detecting the strength of the signals transmitted from the transmitter to the receiver, a display for displaying the strength of the signals, a speaker which emits sound according to the strength of the signals.

7. The emergency area confinement and safety system as claimed in claim 6, wherein the receiver is installed in one of a key, a flashlight, an oxygen mask, an indicator box, a TV controller, a mobile phone, and a rescuing cloth used in a boat and a plane.

8. The emergency area confinement and safety system as claimed in claim 4, wherein the guiding unit further include a sound emitting unit for guiding the people to go out of an accident area by sounds and a lighting unit which emits light to guide people to run out of the accident area.

9. The emergency area confinement and safety system as claimed in claim 3, wherein the transmitter includes at least one of a signal generator, an antenna, a modulator, a multiplexer and an encoder.

10. The emergency area confinement and safety system as claimed in claim 1, wherein the receiver includes:
a detector for detecting the strength of the signals transmitted from the transmitter to the receiver,
a display for displaying the strength of the signals;
a speaker which emits sound according to the strength of the signals; and
a lighting device for emitting light to alert people to run away along a predetermined path.

11. The emergency area confinement and safety system as claimed in claim 10, wherein the receiver further includes at least one of an antenna, a signal processor, a demodulator, a demultiplexer, and a decoder.

12. A method for defining emergency area and solving an accident comprises the steps of
detecting accidents occurred in a building unit by using an detector unit having a plurality of detectors; the detectors being installed to different locations for detecting the conditions of the respective area; each detector is set with a detecting cell;
receiving signals from the detectors and determining whether an accident is occurred by using an accident determination unit; the accident determining unit having an accident determination logic unit for determining an accident being occurred; the accident determination logic unit storing some logics for determining a possible accident;
defining a contour as an unsafe area by using a contour setting unit; wherein the contour setting unit receiving the signals from the accident determination unit to know which section has accident and then determines an unsafe area according to the detecting cells;
isolating the unsafe area from the safety contour by using an isolation unit (step 805); eliminating the accident in the unsafe area by using an accident elimination unit;
informing the accident to people in the building unit by an informing unit;
receiving wireless signals from the informing unit to know messages about the occurring of an accident by using a receiving unit; and
guiding people to run away from the accident area to a safety area; and displaying the states.
